(19) United States
(12) Patent Application Publication
(10) Pub. No.: US 2004/0120605 A1
(43) Pub. Date: Jun. 24, 2004

(54) Edge-oriented interpolation method for deinterlacing with sub-pixel accuracy

(76) Inventors: Wen-Kuo Lin, Taipei (TW); Chung-Yen Lu, Taipei (TW)

Correspondence Address: BIRCH STEWART KOLASCH & BIRCH, PO BOX 747, FALLS CHURCH, VA, 22040-0747, US

(21) Appl. No.: 10/327,146

(22) Filed: Dec. 24, 2002

(51) Int. Cl. G06K 9/32

(52) U.S. Cl. 382/300

(57) ABSTRACT

An edge-oriented interpolation method for deinterlacing with sub-pixel accuracy. To interpolate a missing pixel of a first scan line, first, a first pixel group of a second scan line and a second pixel group of a third scan line in a first orientation are provided, and a third pixel group of the second scan line and a fourth pixel group of the third scan line in a second orientation are provided. Then, a first sub-pixel of the second scan line is calculated according to the first pixel group and the third pixel group, and a second sub-pixel of the third scan line is calculated according to the second pixel group and the fourth pixel group by employing a linear interpolation method or an ideal interpolation function based on the sampling theorem. Thereafter, the missing pixel is interpolated according to the first sub-pixel and the second sub-pixel.

### BACKGROUND OF THE INVENTION

1. Field of the Invention

The present invention relates to an edge-oriented interpolation method for deinterlacing, and particularly to an edge-oriented interpolation method for deinterlacing taking into account the sub-pixel information.

2. Description of the Related Art

In the deinterlacing process, pixels in the missing scan lines are very often reconstructed by intra-field interpolation. That is, the information in the neighboring scan lines of the same field is exploited for pixel value reconstruction, such as shown in FIG. 1. The missing pixel X of scan line y is given by X=(b+e)/2, where b and e are the reference pixels in the neighboring scan lines (y−1 and y+1).

The above intra-field interpolation method is easy and straightforward for practical implementation, but it does not reflect the edge information in a video field, because only the information in the vertical orientation is used. Consequently, the reconstructed edges may have visually annoying staircases, such as at highly contrast diagonal edges.

A better method is edge-oriented interpolation, exploiting more orientation information to reconstruct the missing scan lines. One related art for the edge-oriented intra-field interpolation is shown in FIG. 2. In FIG. 2, the value of the missing pixel X is interpolated with pixel pair {a,f}, {b,e} and {c,d} in three orientations. That is, the value of X is interpolated by the pixel pair that has a minimum difference as follows,

$$X = \{ \begin{matrix}( a + f ) / 2 if Ua = min \{ Ua , Ub , Uc \} \\ ( b + e ) / 2 if Ub = min \{ Ua , Ub , Uc \} \\ ( c + d ) / 2 if Uc = min \{ Ua , Ub , Uc \}\end{matrix}$$

where Ua=|a−f|, Ub=|b−e|, and Uc=|c−d| corresponding to the pixel difference in the orientations of 135, 90 and 45 degrees respectively.

In the above case, the interpolation accuracy only covers the edges oriented between 45 and 135 degrees. Therefore, to improve accuracy in interpolating flatter edges, more pixel pairs in neighboring scan lines can be used, as shown in FIG. 3. In FIG. 3, two more pixel pairs of {i,l} and {j,k} in the orientations of 154 and 26 degrees are employed to interpolate the missing pixel X. Similarly,

$$X = \{ \begin{matrix}( a + f ) / 2 if Ua = min \{ Ua , Ub , Uc , Ui , Uj \} \\ ( b + e ) / 2 if Ub = min \{ Ua , Ub , Uc , Ui , Uj \} \\ ( c + d ) / 2 if Uc = min \{ Ua , Ub , Uc , Ui , Uj \} \\ ( i + l ) / 2 if Ui = min \{ Ua , Ub , Uc , Ui , Uj \} \\ ( j + k ) / 2 if Uj = min \{ Ua , Ub , Uc , Ui , Uj \}\end{matrix}$$

where

Ua=|a−f|, Ub=|b−e|, Uc=|c−d|, Ui=|i−l|, and Uj=|j−k|.

Theoretically, the more number of the pixel pairs in different orientation used, the more accurate the interpolation results for edges oriented at wider angles. However, the interpolated results may converge to an orientation corresponding to the pixel pair having a localized minimum difference if more orientations are used. The interpolated results may lose accuracy.

To prevent the problems discussed above, multiple pixel pairs of the same orientation can be exploited to determine the actual edge orientation. That is, only if the sum of the multiple pixel pairs' difference in one orientation is the minimum, the intra-field interpolation would be performed in that orientation.

FIG. 4 illustrates an example of multi-orientation edge interpolation in three orientations, such as in 45, 90 and 135 degrees. That is, the pixel pairs in 45 degrees are {b,k}, {c,d} and {j,e}, 90 degrees, {a,d}, {b,e} and {c,f}, and in 135 degrees {i,e}, {a,f} and {b,l}.

The missing pixel X is interpolated with the three pixel pairs that have the total minimum difference as follows,

$$X = \{ \begin{matrix}( a + f ) / 2 if Ua = min \{ Ua , Ub , Uc \} \\ ( b + e ) / 2 if Ub = min \{ Ua , Ub , Uc \} \\ ( c + d ) / 2 if Uc = min \{ Ua , Ub , Uc \}\end{matrix}$$

where

Ua=|a−f|+|i−e|+|b−l|, Ub=|b−e|+|a−d|+|c−f|, and

Uc=|c−d|+|b−k|+|j−e|.

Since three neighboring pixel pairs of the same orientation are used to determine the minimum difference, the orientations of the object edge can be more accurately predicted than when using only one pixel pair. However, it is still not robust when the object edge does not pass along the center of pixels. In this situation, the information of sub-pixels must be considered to enhance accuracy.

### SUMMARY OF THE INVENTION

It is therefore an object of the present invention to provide an edge-oriented interpolation method for deinterlacing taking into account the sub-pixel information.

To achieve the above object, the present invention provides an edge-oriented interpolation method for deinterlacing with sub-pixel accuracy. According to the embodiment of the invention, a missing pixel of a first scan line is interpolated.

First, a first pixel group of a second scan line and a second pixel group of a third scan line in a first orientation are provided, and a third pixel group of the second scan line and a fourth pixel group of the third scan line in a second orientation are provided.

Then, a first sub-pixel of the second scan line is calculated according to the first pixel group and the third pixel group, and a second sub-pixel of the third scan line is calculated according to the second pixel group and the fourth pixel group. Thereafter, the missing pixel is interpolated according to the first sub-pixel and the second sub-pixel.

Each of the first pixel group, the second pixel group, the third pixel group, and the fourth pixel group may contain at least one pixel, and the first sub-pixel and the second sub-pixel are calculated by employing a linear interpolation method or an ideal interpolation function based on the sampling theorem.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 illustrates an example of intra-field interpolation using only vertical orientation;

FIG. 2 illustrates an example of edge-oriented interpolation with three orientations;

FIG. 3 illustrates another example of edge-oriented interpolation with five orientations;

FIG. 4 illustrates an example of multi-orientation edge interpolation in three orientations;

FIG. 5 is a flowchart illustrating the operations of the edge-oriented interpolation method for deinterlacing with sub-pixel accuracy according to the embodiment of the present invention; and

FIG. 6 illustrates a preferred embodiment of the present invention for the sub-pixel orientation prediction.

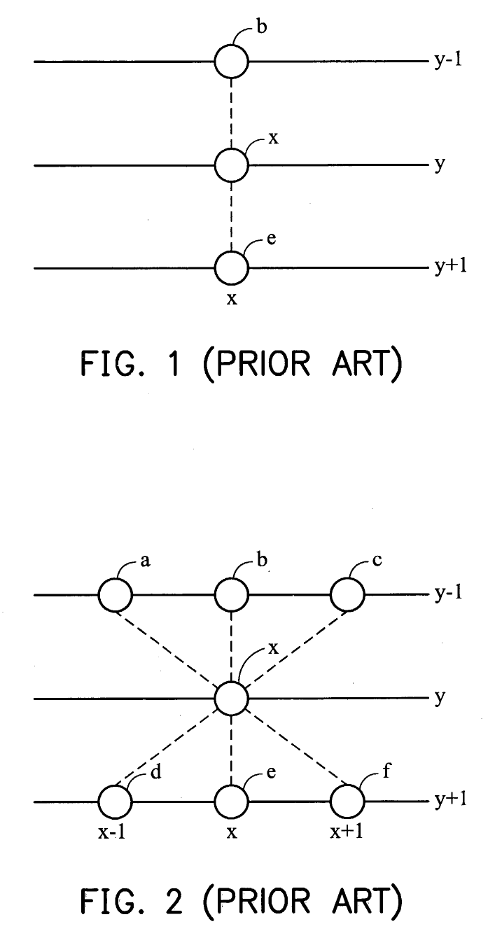

### DETAILED DESCRIPTION OF THE INVENTION

The present invention improves the accuracy for the orientation prediction by exploiting the sub-pixel information. That is, pixel pairs in sub-pixel accuracy are obtained from the original pixels to give a finer edge orientation prediction scale.

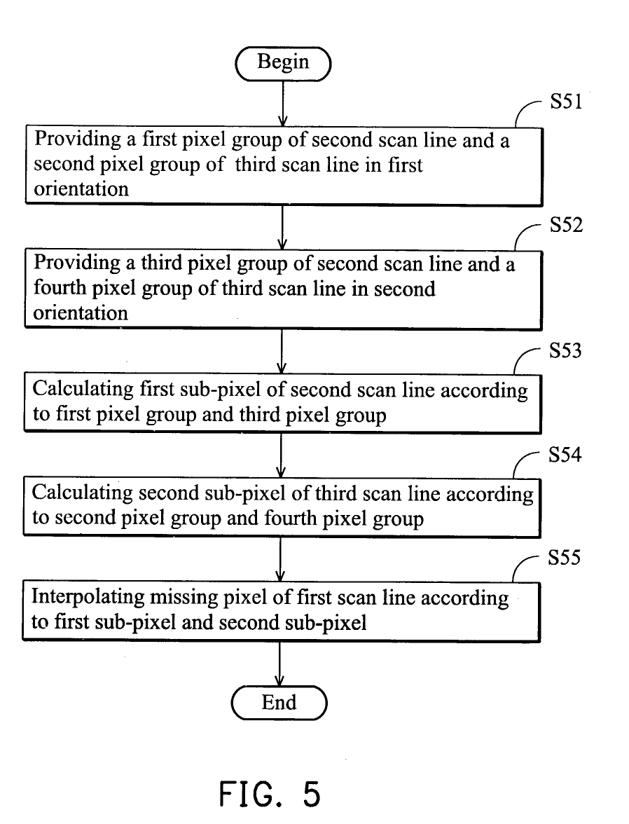

FIG. 5 illustrates the operation of the edge-oriented interpolation method for deinterlacing with sub-pixel accuracy according to the embodiment of the present invention. According to the embodiment of the invention, a missing pixel of a first scan line is interpolated.

First, in step S51, a first pixel group of a second scan line and a second pixel group of a third scan line in a first orientation are provided, and in step S52, a third pixel group of the second scan line and a fourth pixel group of the third scan line in a second orientation are also provided. It should be noted that, each of the first pixel group, the second pixel group, the third pixel group, and the fourth pixel group may contain several pixels.

Then, in step S53, a first sub-pixel of the second scan line is calculated according to the first pixel group and the third pixel group, and in step S54, a second sub-pixel of the third scan line is calculated according to the second pixel group and the fourth pixel group. Thereafter, in step S55, the missing pixel is interpolated according to the first sub-pixel and the second sub-pixel.

It should be noted that the first sub-pixel and the second sub-pixel may be calculated by employing a linear interpolation method or an ideal interpolation function based on the sampling theorem. The ideal interpolation function based on the sampling theorem is briefly introduced as follows.

The sampling process is commonly used in image process. The ideal sampling process can be summarized by the well-known sampling theorem stated as follows:

Assuming the signal Xₐ(t) is bandlimited with bandwidth B, i.e., let Xₐ(F)≡0 for |F|≧B. If Xₐ(t) is sampled at multiples of some basic sampling interval Tₛ, where

$${T}_{S} \leq \frac{1}{2 B}$$

to yield the sequence

$${\{ {X}_{a} ( {nT}_{S} ) \}}_{n = - ∞}^{+ ∞} ,$$

it is then possible to reconstruct the original signal Xₐ(t) from the sampled values by the reconstruction formula,

$${x}_{a} ( t ) = {\sum }_{n = - ∞}^{+ ∞} {x}_{a} ( {nT}_{S} ) sin c ( t - {nT}_{S} ) ,$$

where

$$sin c ( t ) = \frac{sin ( π {tF}_{S} )}{( π {tF}_{S} )} = \frac{sin ( π t / {T}_{S} )}{( π t / {T}_{S} )} ,$$

and called the ideal interpolation function. Since the first sub-pixel and the second sub-pixel can be easily calculated with the ideal interpolation function based on the ideal sampling theorem by those skilled in the imaging process, the detailed process is omitted here.

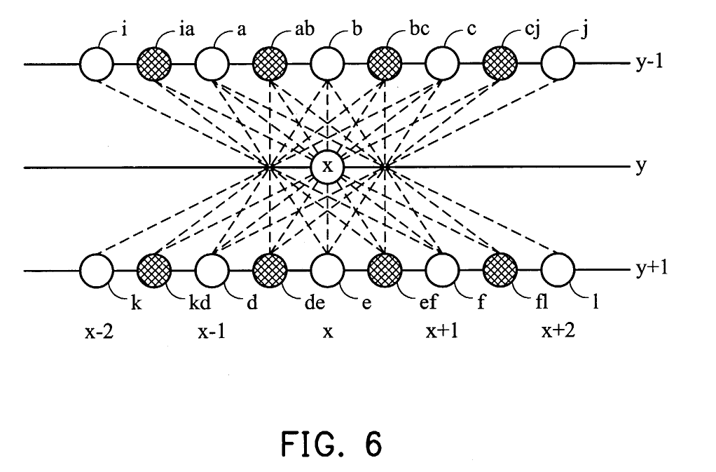

FIG. 6 illustrates a preferred embodiment of the present invention for the sub-pixel orientation prediction. The black points represent the sub-pixels interpolated using the original pixels. For example, pixel ia is interpolated from pixel i and a and given by ia=(i+a)/2. In this case, each pixel group contains one pixel and the linear interpolation method is employed.

Consequently, except the three orientations of 45, 90 and 135 degrees given by the original pixel pairs, the interpolated sub-pixels give four further orientations of 34, 63, 117 and 146 degrees.

Therefore, the three pixel pairs in

34 degrees are {c,k}, {cj,kd} and {j,d},

45 degrees are {bc,kd}, {c,d} and {cj,de},

63 degrees are {b,d}, {bc,de} and {c,e},

90 degrees are {ab,de}, {b,e} and {bc,ef},

117 degrees are {a,e}, {ab,ef} and {b,f},

135 degrees are {ia,ef}, {a,f} and {ab,fl}, and

146 degrees are {i,f}, {ia,fl} and {a,l}.

The value of missing pixel X is then given by,

$$X = \{ \begin{matrix}( a + f ) / 2 if Ua = min \{ Ua , Ub , Uc , Uia , Uab , Ubc , Ucj \} \\ ( b + e ) / 2 if Ub = min \{ Ua , Ub , Uc , Uia , Uab , Ubc , Ucj \} \\ ( c + d ) / 2 if Uc = min \{ Ua , Ub , Uc , Uia , Uab , Ubc , Ucj \} \\ ( ia + fl ) / 2 if Uia = min \{ Ua , Ub , Uc , Uia , Uab , Ubc , Ucj \} \\ ( ab + ef ) / 2 if Uab = min \{ Ua , Ub , Uc , Uia , Uab , Ubc , Ucj \} \\ ( bc + de ) / 2 if Ubc = min \{ Ua , Ub , Uc , Uia , Uab , Ubc , Ucj \} \\ ( cj + jd ) / 2 if Ucj = min \{ Ua , Ub , Uc , Uia , Uab , Ubc , Ucj \}\end{matrix}$$

Where

Ua=|ia−ef|+|a−f|+|ab−fl|, Ub=|ab−de|+b−e|+|bc−ef|,

Uc=|bc−kd|+|c−d|+cj−de|, Uia=|i−f|+|ia−fl|+|a−l|,

Uab=|a−e|+|ab−ef|+|b−f|, Ubc=|b−d|+|bc−de|+|c−e|,

and Ucj=|c−k|+|cj−kd|+|j−d|.

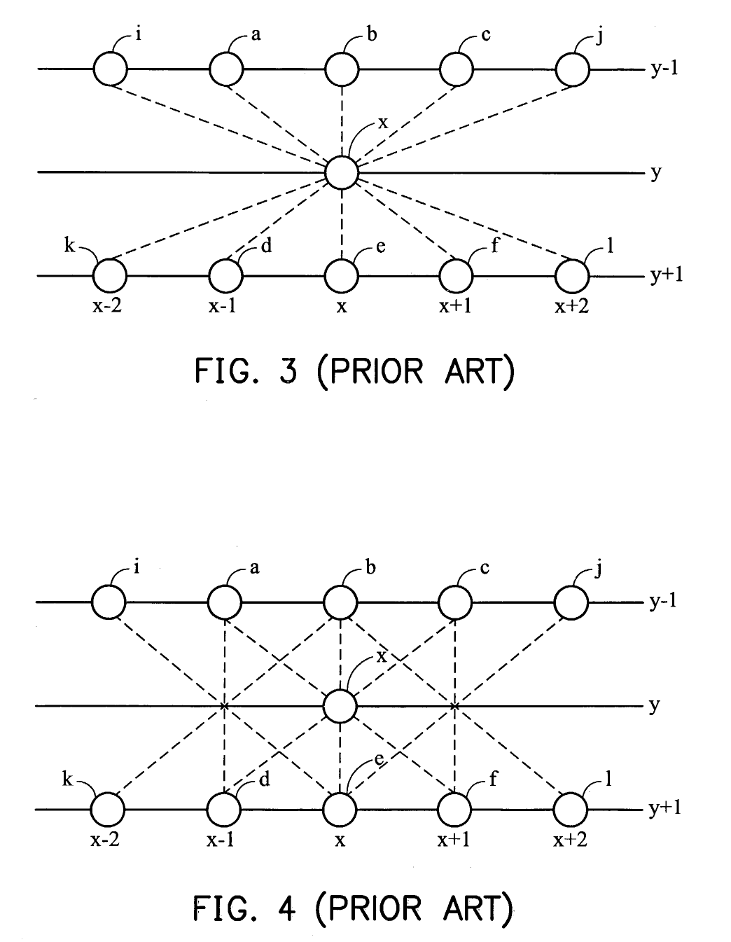

It should be noted that the present invention also can be applied to the edge-oriented interpolation using one pixel pair in one orientation discussed in FIG. 2 and 3, and the detailed process to interpolate the missing pixel is similar thereto and is thus omitted here.

As a result, using the edge-oriented interpolation method for deinterlacing with sub-pixel accuracy according to the present invention, the object edge orientation can be more precisely predicted since pixel pairs with sub-pixel accuracy are used to determine the orientation.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An edge-oriented interpolation method for deinterlacing with sub-pixel accuracy, to interpolate a missing pixel of a first scan line, comprising the steps of:
providing a first pixel group of a second scan line and a second pixel group of a third scan line in a first orientation corresponding to the missing pixel;
providing a third pixel group of the second scan line and a fourth pixel group of the third scan line in a second orientation corresponding to the missing pixel;
calculating a first sub-pixel of the second scan line according to the first pixel group and the third pixel group;
calculating a second sub-pixel of the third scan line according to the second pixel group and the fourth pixel group; and
interpolating the missing pixel according to the first sub-pixel and the second sub-pixel.

2. The edge-oriented interpolation method for deinterlacing with sub-pixel accuracy as claimed in claim 1 further interpolating the missing pixel according to the first pixel group, the third pixel group, and the first sub-pixel of the second scan line, and the second pixel group, the fourth pixel group, and the second sub-pixel of the third scan line.

3. The edge-oriented interpolation method for deinterlacing with sub-pixel accuracy as claimed in claim 1 wherein each of the first pixel group, the second pixel group, the third pixel group, and the fourth pixel group contains at least one pixel.

4. The edge-oriented interpolation method for deinterlacing with sub-pixel accuracy as claimed in claim 1 wherein the first sub-pixel and the second sub-pixel are calculated by employing a linear interpolation method.

5. The edge-oriented interpolation method for deinterlacing with sub-pixel accuracy as claimed in claim 1 wherein the first sub-pixel and the second sub-pixel are calculated by employing an ideal interpolation function based on the sampling theorem.

6. The edge-oriented interpolation method for deinterlacing with sub-pixel accuracy as claimed in claim 1 wherein the second scan line and the third scan line are the neighboring scan lines of the first scan line.
